(19) United States
(12) Patent Application Publication
(10) Pub. No.: US 2014/0300326 A1
(43) Pub. Date: Oct. 9, 2014

(54) ELECTRONIC DEVICE WITH A DUTY CYCLE ESTIMATOR

(71) Applicant: O2Micro, Inc., Santa Clara, CA (US)

(72) Inventors: Shiqiang YANG, Sichuan (CN); Guoyong GUO, San Jose, CA (US)

(21) Appl. No.: 13/933,834

(22) Filed: Jul. 2, 2013

(30) Foreign Application Priority Data
Apr. 3, 2013 (CN) 201310115924.1

(51) Int. Cl. H02J 7/00

(52) U.S. Cl. CPC H02J 7/0052
USPC 320/162

(57) ABSTRACT

A circuit in an electronic device coupled to a battery via a first pair of switches includes a logic unit and a filter. The logic unit receives a pulse width modulation (PWM) signal and a first signal, and generates a second signal according to the PWM signal and the first signal. The filter is coupled to the logic unit and converts the PWM signal into a first voltage under the control of the second signal. When the first voltage is at a voltage of the battery and a duty cycle of the PWM signal is at a specified value, the first pair of switches controls power to the battery under control of the PWM signal and the circuit is disabled by the first signal.

### RELATED APPLICATION

This application claims priority to Chinese Patent Application No. 201310115924.1, titled “An Electronic Device with a Duty Cycle Estimator,” filed on Apr. 3, 2013, with the State Intellectual Property Office of the People's Republic of China, which is incorporated by reference.

### BACKGROUND

FIG. 1 shows a block diagram of a conventional electronic device 100 which provides power to a load, e.g., a battery 150. The electronic device 100 can be a synchronous voltage mode buck charger for charging the battery 150. As shown in FIG. 1, the buck charger 100 includes a power regulator 110, a current source 120, a capacitor 122, a comparator 124, a break-before-make (BBM) circuit 126, a pair of switches including a high side switch 132 (e.g., an N-channel MOSFET) and a low side switch 134 (e.g., an N-channel MOSFET), an inductor 142, a resistor 144, and the battery 150.

The power regulator 110 regulates the power of the battery 150 and is coupled with a negative terminal of the current source 120 and the capacitor 122 at a common node. The capacitor 122 is charged by a reference voltage V_{DD} via the current source 120, and generates a voltage V_{CCHG} at the common node. The comparator 124 compares the voltage V_{CCHG} with a ramp voltage and generates a pulse width modulation (PWM) signal. The BBM circuit 126 receives the PWM signal and generates a drive signal HDR and a drive signal LDR to turn on the high side switch 132 when the low side switch 134 is turned off, and vice versa. The adapter voltage V_{ADP} from an adapter (not shown in FIG. 1) is provided to the battery 150 via the inductor 142 and the resistor 144.

In operation, when the buck charger 100 is powered on, the reference voltage V_{DD} charges the capacitor 122. The voltage V_{CCHG} increases slowly because of the capacity of the capacitor 122. FIG. 2 shows waveforms of signals associated with the buck charger 100. As shown in the example of FIG. 2, before time t1, the voltage V_{CCHG} increases slowly and is less than the ramp voltage, and thus the PWM signal is in a logic low state. At time t1, the voltage V_{CCHG} reaches the ramp voltage, the PWM signal then goes high for a time period T_{ON} which is relatively short, and the duty cycle of the PWM signal is consequently relatively short. At time t2, the voltage V_{CCHG} reaches a constant value that is greater than the ramp voltage, and the PWM signal then goes high for a time period T_{ON}, which is constant from pulse to pulse. Therefore, the time period T_{ON} is constant and at a normal value.

Referring back to FIG. 1, during the time period T_{ON}, the high side switch 132 is turned on and the low side switch 134 is turned off, and the adapter charges the battery 150 via the inductor 142 and the resistor 144. Meanwhile, the inductor 142 stores energy. During the time period T_{OFF}, when the PWM signal is low, the low side switch 134 is turned on and the high side switch 132 is turned off, and the inductor 142 is discharged to provide charging power to the battery 150. Referring back to FIG. 2, between time t1 to time t2, the time period T_{ON} of the PWM signal is relatively short, and the time period T_{OFF} of the PWM signal is relatively long; therefore, the inductor current I_{L} is reversely increased from time t1 to time t2. Thus, the battery 150 becomes a power source to charge back to the adapter, and the adapter voltage is boosted to a relatively high level. It is dangerous if the adapter voltage is boosted to a level that is too high for the charger for a relatively long time period.

Conventionally, there are several methods to solve the problem of reverse charging. One of the methods is to make the buck charger 100 work in an asynchronous mode when the charging current I_{CHG} is relatively low. However, it is difficult to set a threshold for the buck charger 100 to convert from the asynchronous mode to a synchronous mode. Moreover, the buck charger 100 is likely to oscillate when converting from the asynchronous mode to the synchronous mode. Another method is to use a Zero Current Detector (ZCD) to turn off the low side switch 134 when the inductor current I_{L} decreases to zero. However, it is difficult to detect the inductor current I_{L}, especially for a high operational switch frequency.

### SUMMARY

In one embodiment, a circuit in an electronic device coupled to a battery via a first pair of switches includes a logic unit and a filter. The logic unit receives a pulse width modulation (PWM) signal and a first signal, and generates a second signal according to the PWM signal and the first signal. The filter is coupled to the logic unit and converts the PWM signal into a first voltage under the control of the second signal. When the first voltage is at a voltage of the battery and a duty cycle of the PWM signal is at a specified value, the first pair of switches controls power to the battery under control of the PWM signal and the circuit is disabled by the first signal.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a block diagram of a conventional electronic device which provides power to a load.

FIG. 2 shows the waveforms of signals associated with the electronic device in FIG. 1.

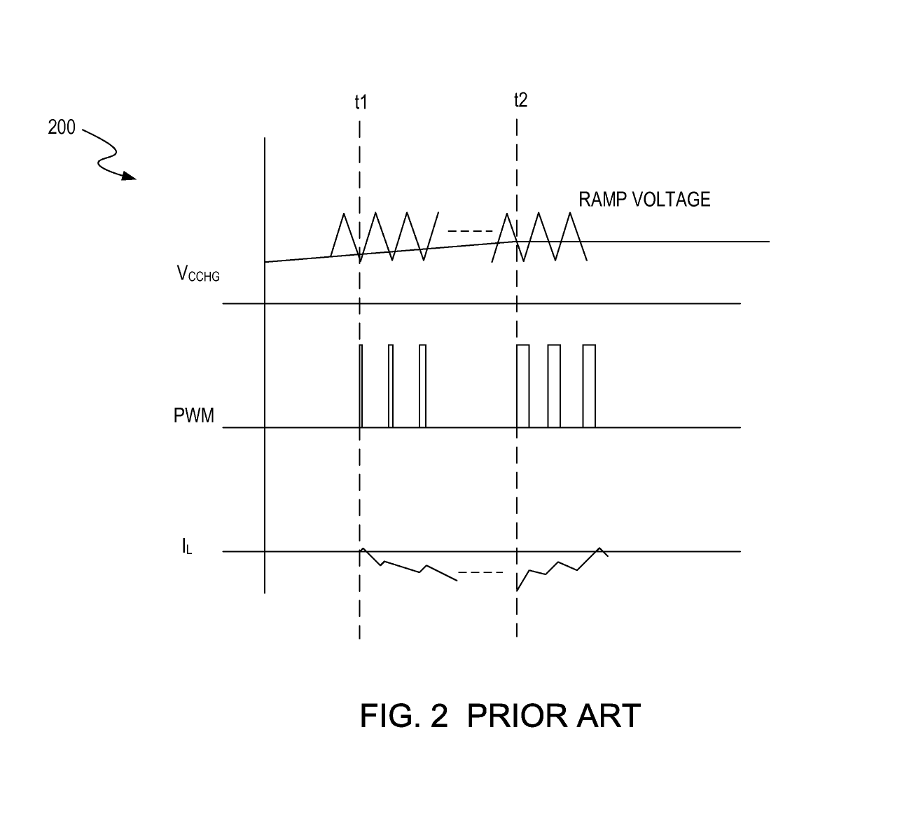

FIG. 3 shows a block diagram of an example of an electronic device with a duty cycle estimator, in an embodiment according to the present invention.

FIG. 4 shows a detailed block diagram of an example of an electronic device with a duty cycle estimator, in an embodiment according to the present invention.

FIG. 5 shows the waveforms of signals associated with an electronic device, in an embodiment according to the present invention.

FIG. 6 shows another detailed block diagram of an example of an electronic device with a duty cycle estimator, in an embodiment according to the present invention.

FIG. 7 shows a flowchart of examples of operations performed by an electronic device with a duty cycle estimator, in an embodiment according to the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

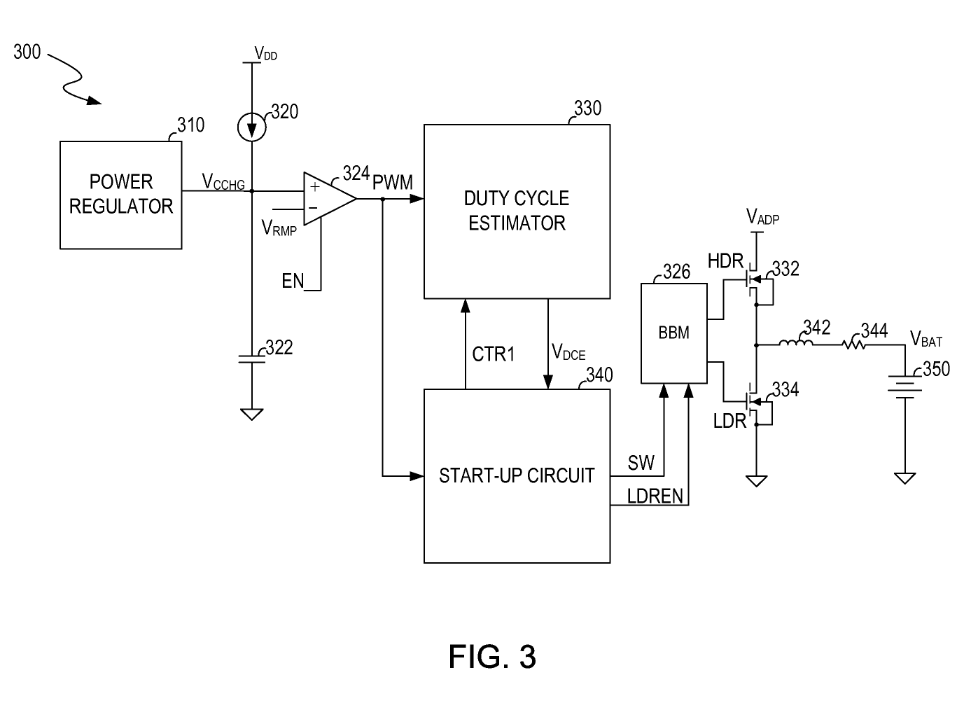

FIG. 3 shows a block diagram of an example of an electronic device 300 with a duty cycle estimator 330, in an embodiment according to the present invention. In one embodiment, the electronic device 300 is a synchronous voltage mode buck charger 300 for providing power to a load, e.g., a battery 350. The electronic device 300 includes a power regulator 310, a current source 320, a capacitor 322, a comparator 324, a break-before-make (BBM) circuit 326, a pair of switches including a high side switch 332 (e.g., an N-channel MOSFET) and a low side switch 334 (e.g., an N-channel MOSFET), an inductor 342, a resistor 344, a duty cycle estimator 330, and a start-up circuit 340.

In one embodiment, the power regulator 310 is coupled with a negative terminal of the current source 320 and the capacitor 322 at a common node. The capacitor 322 is charged by a reference voltage V_{DD} via the current source 320, and generates a voltage V_{CCHG} at the common node. The comparator 324 compares the voltage V_{CCHG} with a ramp voltage V_{RMP} and generates a pulse width modulation (PWM) signal. The duty cycle estimator 330 is coupled to an output of the comparator 324 and the start-up circuit 340. The duty cycle estimator 330 receives the PWM signal generated by the comparator 324 and a first control signal CTR1 generated by the start-up circuit 340, converts the PWM signal into a first voltage V_{DCE}, and sends the first voltage V_{DCE} to the start-up circuit 340. The start-up circuit 340 receives the first voltage V_{DCE} and the PWM signal from the comparator 324, and generates the first control signal CTR1, which is received by the duty cycle estimator 330. The start-up circuit 340 further outputs a switch control signal SW to control the pair of switches 332 and 334, and a low side switch control signal LDREN to enable or disable the operation of the low side switch 334.

In one embodiment, when the duty cycle D of the PWM signal is increasing but has not increased to a specified value, the first voltage V_{DCE} is less than an initial voltage V_{BAT}_{_{—}}ᵢₙᵢ of the battery 350. (The initial voltage of the battery 350 before the battery is charged by the electronic device 300 is regarded as the initial voltage V_{BAT}_{_{—}}ᵢₙᵢ. If, for example, the battery 350 is new and has not yet been charged by the electronic device 300 or any other charging device, then the initial voltage may be zero. If, for example, the battery 350 has been previously charged and used, then the initial voltage is the value after use but before the battery is charged by the electronic device 300.) In this situation, the start-up circuit 340 outputs the switch control signal SW in a single state, for example, logic low, to turn off the high side switch 332. The start-up circuit 340 further outputs the low side switch control signal LDREN in a low state to disable the low side switch 334. Therefore, no power is provided to the battery 350 when the first voltage V_{DCE} is less than the initial voltage V_{BAT}_{_{—}}ᵢₙᵢ of the battery 350.

When duty cycle D of the PWM signal increases to the specified value, the first voltage V_{DCE} is equal to the initial voltage V_{BAT}_{_{—}}ᵢₙᵢ of the battery 350. The specified value of the duty cycle D is given by equation (1):

D=V_{BAT}_{_{—}}ᵢₙᵢ/V_{ADP}; (1)

where V_{ADP} is the adapter voltage, and V_{BAT}_{_{—}}ᵢₙᵢ is the initial voltage of the battery 350 before the battery is charged by the electronic device 300.

In this situation, the duty cycle estimator 330 is disabled under control of the first control signal CTR1, and the first voltage V_{DCE} drops to zero. The start-up circuit 340 outputs the PWM signal as the switch control signal SW to control the high side switch 332 and the low side switch 334. The low side switch control signal LDREN output by the start-up circuit 340 goes high, which enables the low side switch 334. Therefore, when the first voltage V_{DCE} is equal to the initial voltage V_{BAT}_{_{—}}ᵢₙᵢ of the battery 350, the start-up circuit 340 outputs the PWM signal to provide power to the battery 350, as the high side switch 132 is turned on when the low side switch 134 is turned off and vice versa in response to the PWM signal.

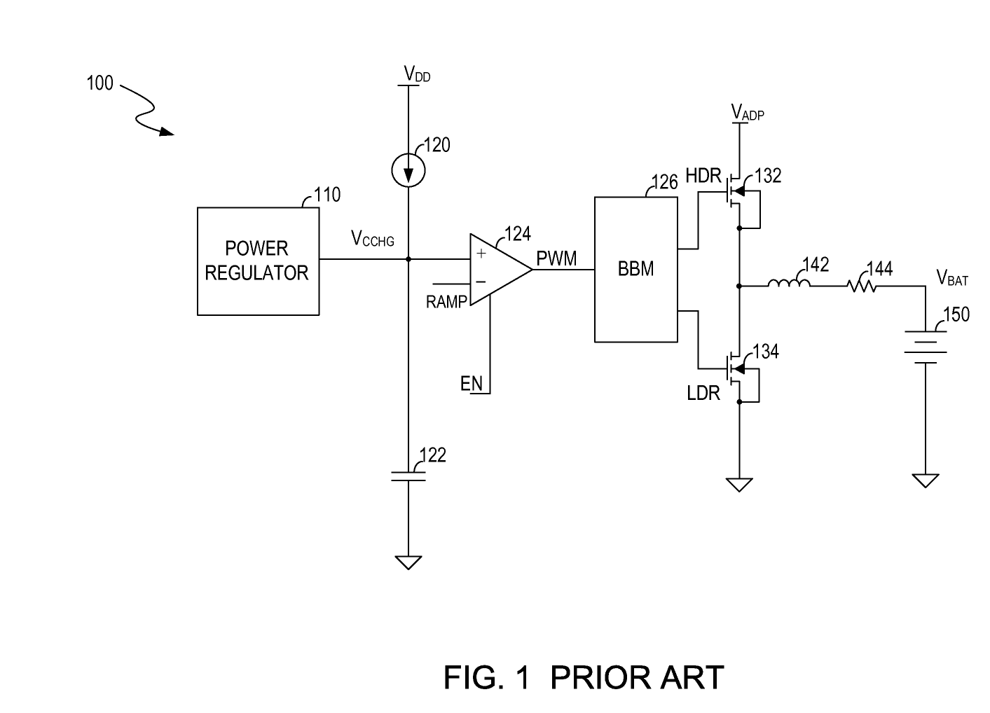

Advantageously, by using the duty cycle estimator 330 and the start-up circuit 340 in the electronic device 300, no PWM signal is provided to control the pair of switches 332 and 334 when the duty cycle D of the PWM signal is relatively small and not at a specified value (V_{BAT}_{_{—}}ᵢₙᵢ/V_{ADP}). Until the duty cycle D is at the specified value, the time period T_{ON} of the PWM signal is not relatively short, and the PWM signal is provided to turn on the high side switch 332 while turning off the low side 334 and vice versa as described above to charge the battery 350. Thus, the problems that occurred in the conventional system 100 shown in FIG. 1 are avoided.

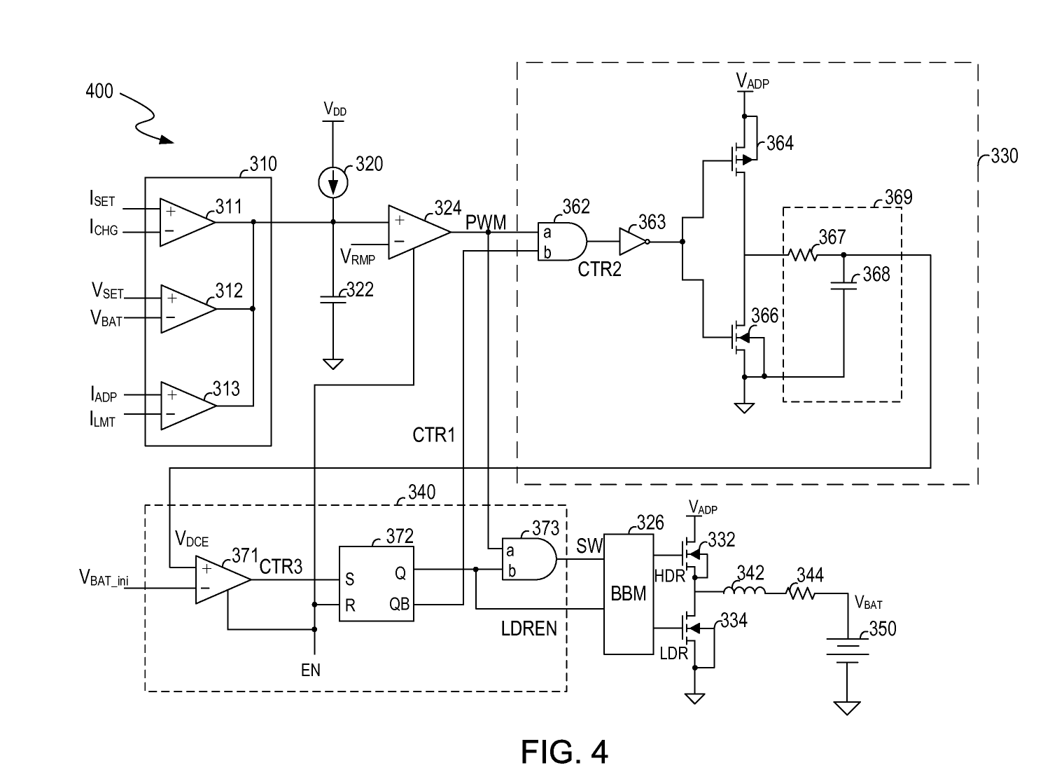

FIG. 4 shows a detailed block diagram of an example of an electronic device 400 with a duty cycle estimator 330, in an embodiment according to the present invention. Elements having similar functions as in FIG. 3 are labeled the same and will not be repetitively described herein for purposes of brevity and clarity. In one embodiment, the electronic device 400 is a synchronous voltage mode buck charger 400 for providing power to a load, e.g., the battery 350.

As shown in the example of FIG. 4, the power regulator 310 includes multiple error amplifiers, for example, a first error amplifier 311, a second error amplifier 312, and a third error amplifier 313. The three error amplifiers 311, 312, and 313 are coupled together at the common node with the negative terminal of the current source 320, an input terminal (e.g., a non-inverting input terminal) of the comparator 324, and the capacitor 322. The duty cycle estimator 330 includes a logic unit (e.g., an AND gate 362), an inverting driver 363, a pair of switches including a high side switch 364 (e.g., a P-type MOSFET) and a low side switch 366 (e.g., an N-type MOSFET), and a filter 369, for example, an RC filter including a resistor 367 and a capacitor 368. The start-up circuit 340 includes a comparator 371, a flip-flop 372, and a logic unit, such as an AND gate 373.

As shown in the example of FIG. 4, an input of the AND gate 362 is coupled to an output terminal of the comparator 324 to receive the PWM signal, and another input of the AND gate 362 is coupled to an output terminal QB (e.g., the inverting output terminal) of the flip-flop 372 in the start-up circuit 340 to receive the first control signal CTR1. The AND gate 362 generates a second control signal CTR2 according to the PWM signal and the first control signal CTR1. The second control signal CTR2 is transferred via the inverting driver 363 to control the pair of the switches 364 and 366. The RC filter 369 is coupled to the pair of the switches 364 and 366 and converts the PWM signal into the first voltage V_{DCE} under control of the second control signal CTR2.

In one embodiment, the duty cycle estimator 330 is enabled or disabled under control of the first control signal CTR1. More specifically, when the first control signal CTR1 is in a first state, e.g., a logic high state, and the PWM signal is provided, the AND gate 322 outputs the PWM signal as the second control signal CTR2 to control the pair of switches 364 and 366 as described above via the inverting driver 363. For example, the switch 364 is turned on when the switch 366 is turned off under control of the second control signal CTR2, and vice versa. Thus, the input voltage of the duty cycle estimator 330, which is equal to the adapter voltage V_{ADP} of the electronic device 400, is transferred to the RC filter 369 at a duty cycle equal to the duty cycle D of the PWM signal; therefore, the RC filter 369 converts the PWM signal into the first voltage V_{DCE} under control of the second control signal CTR2. Thus, the duty cycle estimator 330 is enabled when the first control signal CTR1 is logic high and the PWM signal is provided. When the first control signal CTR1 is in a second state, e.g., logic low, the second control signal CTR2 output by the AND gate 362 goes low, which turns off the switch 364 while turns on the switch 366, and the first voltage V_{DCE} drops to zero; therefore, the duty cycle estimator 330 is disabled.

As shown in the example of FIG. 4, an input terminal (e.g., non-inverting input terminal) of the comparator 371 is coupled to the RC filter 369 to receive the first voltage V_{DCE} generated by the RC filter 369. Another input terminal (e.g., inverting input terminal) of the comparator 371 receives the initial voltage V_{BAT}_{_{—}}ᵢₙᵢ of the battery 350, which is the initial voltage of the battery 350 before the battery 350 is charged by the electronic device 400. The comparator 371 generates a third control signal CTR3 in accordance with the comparison of the first voltage V_{DCE} with the initial voltage V_{BAT}_{_{—}}ᵢₙᵢ of the battery 350.

In one embodiment, the flip-flop 372 can be an RS flip-flop with an R terminal, an S terminal, a non-inverting output terminal Q, and an inverting output terminal QB. As shown in the example of FIG. 4, the S terminal of the RS flip-flop 372 is coupled to the output terminal of the comparator 371 to receive the third control signal CTR3. The R terminal receives an enable signal EN which can be generated by the user. The enable signal EN is in a logic high state to enable the comparators 324 and 371. Thus, the first control signal CTR1 at the inverting output terminal QB of the flip-flop 372 is generated in response to the third control signal CTR3 at the S terminal. The first control signal CTR1 is sent to the duty cycle estimator 330 to enable or disable the duty cycle estimator 330. In one embodiment, when the first voltage V_{DCE} is less than the initial voltage V_{BAT}_{_{—}}ᵢₙᵢ of the battery 350, the first control signal CTR1 goes high to enable the duty cycle estimator 330; when the first voltage V_{DCE} is equal to the initial voltage V_{BAT}_{_{—}}ᵢₙᵢ of the battery 350, the first control signal CTR1 goes low to disable the duty cycle estimator 330.

As shown in the example of FIG. 4, an input of the AND gate 373 is coupled to the non-inverting output terminal Q of the flip-flop 372, and another input of the AND gate 343 is coupled to the output terminal of the comparator 324 to receive the PWM signal. The AND gate 373 generates a switch control signal SW at the output to control the pair of the switches 332 and 334. In one embodiment, when the first voltage V_{DCE} is less than the initial voltage V_{BAT}_{_{—}}ᵢₙᵢ of the battery 350, the switch control signal SW generated by the AND gate 373 has a single state, e.g., logic low state, which turns off the high side switch 332. When the first voltage V_{DCE} is at the initial voltage V_{BAT}_{_{—}}ᵢₙᵢ of the battery 350, the start-up circuit 340 outputs the PWM signal as the switch control signal SW to control the switches 332 and 334.

As shown in the example of FIG. 4, the non-inverting output terminal Q of the flip-flop 372 is also coupled to the BBM circuit 326 to send a low side switch control signal LDREN to the BBM circuit 326 to enable or disable the low side switch 334. More specifically, when the first voltage V_{DCE} is less than the initial voltage V_{BAT}_{_{—}}ᵢₙᵢ of the battery 350, the low side switch control signal LDREN is in a logic low state which disables the low side switch 334. When the first voltage V_{DCE} is at the initial voltage V_{BAT}_{_{—}}ᵢₙᵢ of the battery 350, the low side switch control signal LDREN is in a logic high state, which enables the low side switch 334. Therefore, as described above, when the first voltage V_{DCE} is less than the initial voltage V_{BAT}_{_{—}}ᵢₙᵢ of the battery 350, both of the switches 332 and 334 are turned off, and when the first voltage V_{DCE} is at the initial voltage V_{BAT}_{_{—}}ᵢₙᵢ of the battery 150, the switches 332 and 334 are turned on or off as described above in response to the PWM signal to provide power to the battery 350. For example, the high side switch 332 is turned on when the low side switch 334 is turned off under control of the PWM signal, and vice versa.

Moreover, in one embodiment, the power regulator 310 regulates power of the battery 350 by monitoring the status of the battery 350, such as the charging current I_{CHG} and the battery voltage V_{BAT}. More specifically, the first error amplifier 311 compares the charging current I_{CHG} with a predetermined current I_{SET}, and generates a negative output when the charging current I_{CHG} is greater than the predetermined current I_{SET}. The second error amplifier 312 compares the battery voltage V_{BAT} with a predetermined voltage V_{SET}, and generates a negative output when the battery voltage V_{BAT} is greater than the predetermined voltage V_{SET}. Moreover, the power regulator 310 can further regulate power from the adapter (not shown in FIG. 4), by comparing the adapter current I_{ADP} with a current limit I_{LMT} for the adapter using the third error amplifier 313. When the adapter current I_{ADP} is greater than the current limit I_{LMT}, the output of the third error amplifier 313 is negative.

The error amplifiers 311, 312, and 313 are coupled together at the common node with the capacitor 322. Thus, the voltage V_{CCHG} at the common node is decreased by a negative output generated by any of the error amplifiers 311, 312, and 313, and therefore the time period T_{ON} of the PWM signal shortens accordingly. Consequently, the charging current I_{CHG} the battery voltage V_{BAT}, or the adapter current I_{ADP} is decreased in response to the shortening of the time period T_{ON}.

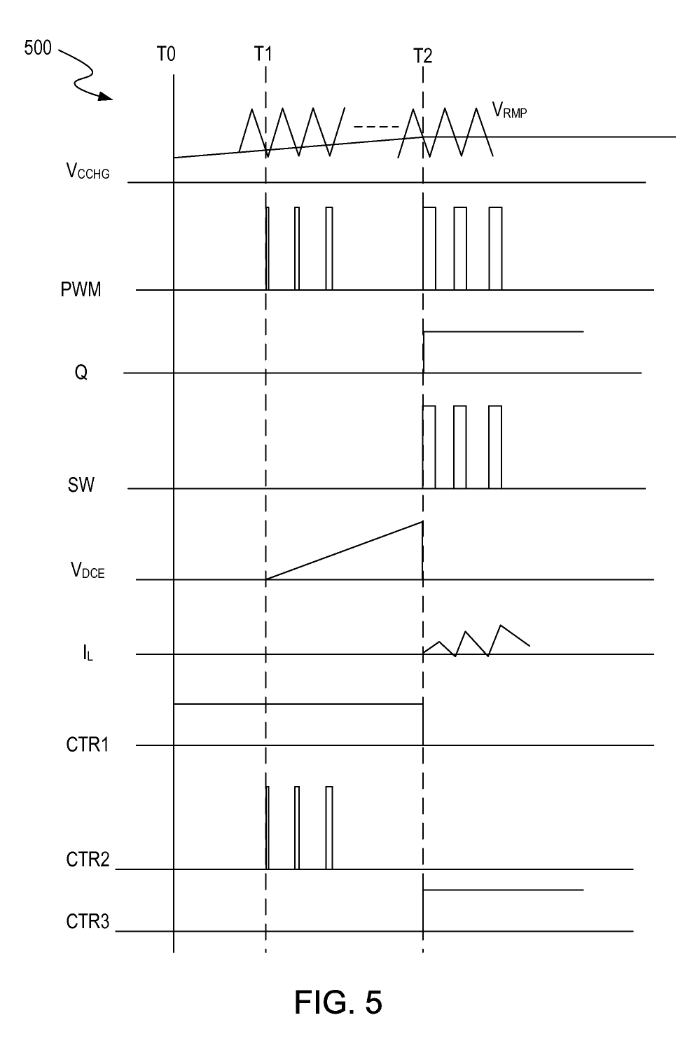

FIG. 5 shows the waveforms of signals associated with the electronic device 400 in FIG. 4, in accordance with one embodiment of the present invention. FIG. 5 is described in combination with FIG. 4.

At time T0, the electronic device 400 is powered on, and the reference voltage V_{DD} starts to charge the capacitor 322. The capacitor 322 is a compensation capacitor with relatively large capacity, and so the voltage V_{CCHG} increases slowly and is less than the ramp voltage V_{RMP}. Thus, the output of the comparator 324 goes low, and the second control signal CTR2 output by the AND gate 362 is in a logic low state, accordingly. Therefore, the first voltage V_{DCE} is zero, which is less than the initial voltage V_{BAT}_{_{—}}ᵢₙᵢ of the battery 350, and the third control signal CTR3 goes low, accordingly. The non-inverting output terminal Q of the flip-flop 372 goes low while the first control signal CTR1 at the inverting output terminal QB goes high; thus, the low side switch control signal LDREN signal goes low, and the output signal SW of the AND gate 373 also goes low. Therefore, the switches 332 and 334 are turned off, and no current flows through the inductor 342.

At time T1, the voltage V_{CCHG} increases to the ramp voltage V_{RMP}, and the PWM signal is provided by the comparator 324. The first control signal CTR1 is logic high, and so the AND gate 362 outputs the PWM signal as the second control signal CTR2. The second control signal CTR2 controls the switches 364 and 366 with a duty cycle equal to that of the PWM signal; therefore, the PWM signal is converted by the filter 369 into the first voltage V_{DCE}. As shown in the example of FIG. 5, the first voltage V_{DCE} is a direct current (DC) voltage, which increases with the increasing of the duty cycle D of the PWM signal. Thus, the duty cycle estimator 330 is enabled when the first control signal CTR1 is logic high and the PWM signal is provided.

Because the duty cycle D of the PWM signal is increasing but still less than a specified value (V_{BAT}_{_{—}}ᵢₙᵢ/V_{ADP}), the first voltage V_{DCE} is also still less than the initial voltage V_{BAT}_{_{—}}ᵢₙᵢ of the battery 350, the third control signal CTR3 goes low, and the non-inverting output terminal Q of the flip-flop 372 goes low, too. Therefore, the switch control signal SW at the output of the AND gate 373 and the low side switch control signal LDREN are in low states, which turn off the switches 332 and 334; thus, no current flows through the inductor 342 when the first voltage V_{DCE} is less than the initial voltage V_{BAT}_{_{—}}ᵢₙᵢ of the battery 350.

With the increasing of duty cycle D of the PWM signal, at time T2, the duty cycle D of the PWM signal increases to a specified value (V_{BAT}_{_{—}}ᵢₙᵢ/V_{ADP}), and the first voltage V_{DCE} increases to the initial voltage V_{BAT}_{_{—}}ᵢₙᵢ of the battery 350. The output of the comparator 371 goes high, and the non-inverting output terminal Q goes high, while the inverting output terminal QB of the flip-flop 372 goes low; thus, the first control signal CTR1 is in a low state. Consequently, the second control signal CTR2 at the output of the AND gate 362 goes low, which turns off the switch 364 while turns on the switch 366. Thus, the duty cycle estimator 330 is disabled from time T2 under control of the first control signal CTR1, and the first voltage V_{DCE} drops to zero when the duty cycle D of the PWM signal is at the specified value.

When the output signal at the inverting output terminal Q of the flip-flop 372 goes high, the low side switch control signal LDREN goes high, which enables the low side switch 332. The PWM signal is output by the AND gate 373 as the switch control signal SW to control the switches 332 and 334. Therefore, at time T2, when the duty cycle D of the PWM signal is at the specified threshold value, the PWM signal is output by the start-up circuit 340 to start charging of the battery 350.

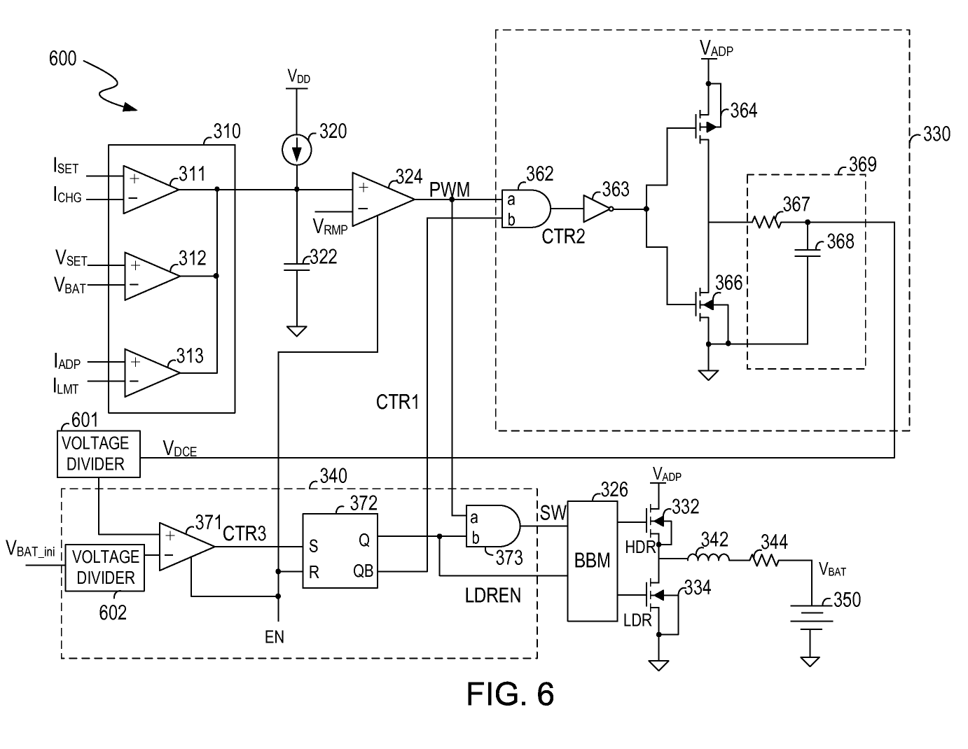

FIG. 6 shows another block diagram of an example of an electronic device 600 with a duty cycle estimator 330, in an embodiment according to the present invention. A first voltage divider 601 and a second voltage divider 602 are coupled to the non-inverting input terminal and the inverting input terminal of the comparator 371, respectively. All other elements and configurations are the same as shown in FIG. 4. Therefore, elements having similar functions as in FIG. 4 are labeled the same and will not be receptively described herein for the purposes of brevity and clarity.

As shown in the example of FIG. 6, the first voltage divider 601 receives the first voltage V_{DCE}, and divides the first voltage V_{DCE} to generate a first voltage signal indicative of the first voltage V_{DCE}. The second voltage divider 602 receives the initial voltage V_{BAT}_{_{—}}ᵢₙᵢ of the battery, and divides the initial voltage V_{BAT}_{_{—}}ᵢₙᵢ of the battery to generate a second voltage signal indicative of the initial voltage V_{BAT}_{_{—}}ᵢₙᵢ of the battery. The comparator 371 compares the first voltage signal and the second voltage signal, and generates the third control signal CTR3 accordingly.

In one embodiment, the first voltage divider 601 and the second voltage divider 602 have similar configurations; therefore, as described above, when the duty cycle D of the PWM signal is at the specified value (V_{BAT}_{_{—}}ᵢₙᵢ/V_{ADP}), the first voltage V_{DCE} is equal to the initial voltage V_{BAT}_{_{—}}ᵢₙᵢ of the battery 350, the first control signal CTR1 is in a first state, e.g. a low state, and the duty cycle estimator 330 is disabled under the control of the first control signal CTR1. Also, the start-up circuit 340 outputs the PWM signal as the switch control signal SW to control the switches 332 and 334 as described above to provide power to the battery 350.

Advantageously, by using the first and second voltage dividers 601 and 602, the electronic device 600 shown in FIG. 6 can be used with a battery characterized as having a large initial voltage, for example, a battery module.

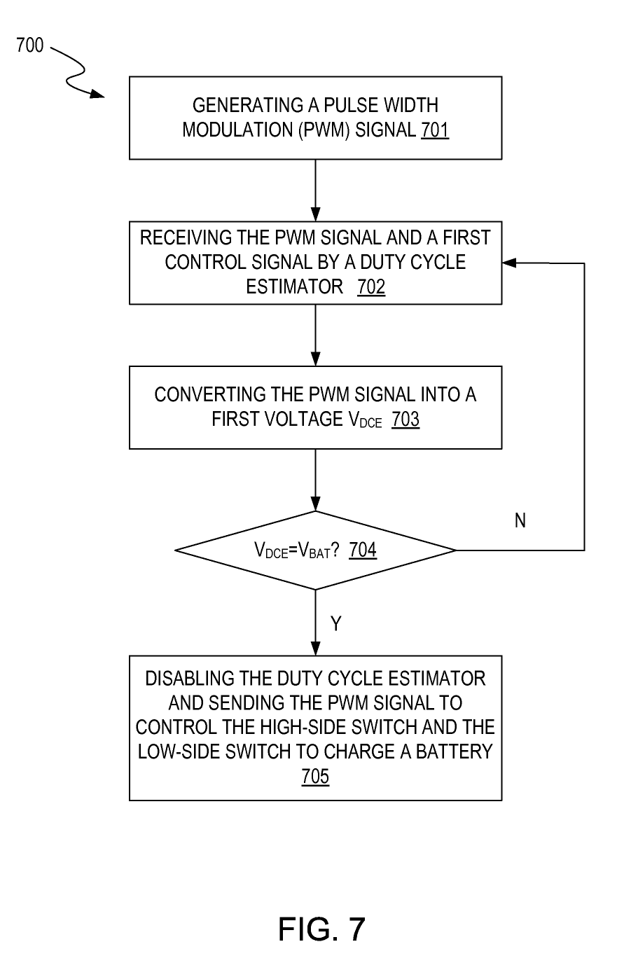

FIG. 7 shows a flowchart 700 of examples of operations performed by an electronic device with a duty cycle estimator, in an embodiment according to the present invention. FIG. 7 is described in combination with FIG. 4 and FIG. 6. Although specific steps are disclosed in FIG. 7, such steps are exemplary. That is, the present invention is well suited to performing various other steps or variations of the steps recited in FIG. 7.

At block 701, a comparator 324 in an electronic device 400 (600) generates a PWM signal by comparing a voltage V_{CCHG} with a ramp voltage V_{RMP}. In one embodiment, the voltage V_{CCHG} is generated by charging a capacitor 322 at a common node with the comparator 324.

In block 702, a duty cycle estimator 330 in the electronic device receives the PWM signal and a first control signal CTR1. In one embodiment, the first control signal CTR1 is generated by a start-up circuit 340 in the electronic device. When the PWM signal is provided and the first control signal CTR1 is in a first state, e.g., logic high, the duty cycle estimator 330 is enabled. When the first control signal CTR1 is in a second state, e.g., logic low, the duty cycle estimator 330 is disabled.

In block 703, the duty cycle estimator 330 converts the PWM signal into a first voltage V_{DCE}. More specifically, a logic unit, for example, an AND gate 362, of the duty cycle estimator 330 receives the first control signal CTR1 and the PWM signal, and generates a second control signal CTR2 according to the PWM signal and the first control signal CTR1.

In one embodiment, the duty cycle estimator 330 includes a pair of switches (switches 364 and 366) and a filter 369 coupled to the AND gate 362. When the first control signal CTR1 is in a high state, the AND gate 362 outputs the PWM signal as the second control signal CTR2 to control the pair of the switches 364 and 366 as described above via an inverting driver 363. For example, the switch 364 is turned on when the switch 366 is turned off under control of the second control signal CTR2, and vice versa. Thus, the input voltage of the duty cycle estimator 330, which is equal to the adapter voltage V_{ADP} of the electronic device, is transferred to the filter 369 with a duty cycle equal to that of the PWM signal; therefore, the filter 369 converts the PWM signal into the first voltage V_{DCE} under control of the second control signal CTR2.

In block 704, the start-up circuit 340 receives the first voltage V_{DCE}, and compares the first voltage V_{DCE} with an initial voltage V_{BAT}_{_{—}}ᵢₙᵢ of the battery 350. In one embodiment, a comparator 371 in the start-up circuit 340 generates a third control signal CTR3 in accordance with a comparison of the first voltage V_{DCE} with the initial voltage V_{BAT}_{_{—}}ᵢₙᵢ of the battery 350.

When the first voltage V_{DCE} is less than the initial voltage V_{BAT}_{_{—}}ᵢₙᵢ of the battery 350, the third control signal CTR3 generated by the comparator 371 goes low. A flip-flop 372 in the start-up circuit 340 receives the third control signal CTR3 at an S terminal and generates an output signal with a low state at the non-inverting output terminal Q. The flip-flop 372 further generates the first control signal CTR1 as an output signal at the inverting output terminal QB in response to the third control signal CTR3; therefore, the first control signal CTR1 is in a high state when the first voltage V_{DCE} is less than the initial voltage V_{BAT}_{_{—}}ᵢₙᵢ of the battery 350.

Although the start-up circuit 340 receives the PWM signal, the start-up circuit 340 outputs a switch control signal SW in a single state by using an AND gate 373, e.g., logic low, to turn off a high switch 332 of the electronic device. The output signal at the non-inverting output terminal Q of the flip-flop 372 is output by the start-up circuit 340 as a low side switch control signal LDREN to disable the low side switch 334. Therefore, no current flows through the inductor 342. Thus, when the first voltage V_{DCE} is less than the initial voltage V_{BAT}_{_{—}}ᵢₙᵢ of the battery 350, the flowchart 700 goes to the block 702 to convert the PWM signal into the first voltage V_{DCE}.

When the duty cycle D of the PWM signal increases to a specified value (V_{BAT}_{_{—}}ᵢₙᵢ/V_{ADP}), the first voltage V_{DCE} increases to the initial voltage V_{BAT}_{_{—}}ᵢₙᵢ of the battery 350, and the flowchart 700 goes to the block 705. In block 705, the duty cycle estimator 330 is disabled, and the start-up circuit 340 outputs the PWM signal as the switch control signal SW to control the switches 332 and 334 as described above to start charging the load, e.g., the battery 350 of the electronic device 400 (600).

More specifically, when the duty cycle of the PWM signal is at the specified value (V_{BAT}_{_{—}}ᵢₙᵢ/V_{ADP}), the first voltage V_{DCE} increases to the initial voltage V_{BAT}_{_{—}}ᵢₙᵢ of the battery 350, and the third control signal CTR3 goes high, which makes the first control signal CTR1 goes low. Thus, the second control signal CTR2 generated by the duty cycle estimator 330 goes low, which turns off the switch 364 while turns on the switch 366, the first voltage V_{DCE} then drops to zero, and the duty cycle estimator 330 is disabled under control of the first control signal CTR1.

As the third control signal CTR3 goes high, the output signal at the non-inverting output terminal Q of the flip-flop 372 goes high, too. As the AND gate 373 receives the output signal at the non-inverting output terminal Q and the PWM signal from the comparator 324, the AND gate 373 outputs the PWM signal as the switch control signal SW. Moreover, the low side switch control signal LDREN goes high to enable the operation of the low side switch 334. Thus, the PWM signal output by the AND gate 343 controls the switches 332 and 334 as described above to provide power to the battery 150.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A circuit in an electronic device coupled to a battery via a first pair of switches, said circuit comprising:
a logic unit, that receives a pulse width modulation (PWM) signal and a first signal, and generates a second signal according to said PWM signal and said first signal; and
a filter, coupled to said logic unit, that converts said PWM signal into a first voltage under control of said second signal,
wherein when said first voltage is at a voltage of said battery and a duty cycle of said PWM signal is at a specified value, said first pair of switches controls power to said battery under control of said PWM signal and said circuit is disabled by said first signal.

2. The circuit of claim 1, wherein when said circuit is disabled, a duty cycle of said PWM signal is at said specified value which is proportional to said voltage of said battery.

3. The circuit of claim 1, wherein when said circuit is disabled, a duty cycle of said PWM signal is at said specified value which is inversely proportional to an input voltage of said circuit.

4. The circuit of claim 1, wherein said first voltage drops to zero when said circuit is disabled.

5. The circuit of claim 1, further comprising:
a second pair of switches, coupled to said logic unit and said filter, that is controlled by said second signal and transfers a second voltage at a duty cycle equal to a duty cycle of said PWM signal to said filter to generate said first voltage.

6. An electronic device operable for providing power to a battery, said electronic device comprising:
a first circuit, that receives a pulse width modulation (PWM) signal and a first signal, and converts said PWM signal into a first voltage;
a start-up circuit, coupled to said first circuit, that receives said PWM signal and said first voltage, generates said first signal, and outputs said PWM signal to provide power to said battery when said first voltage is at a voltage of said battery and a duty cycle of said PWM signal is at a specified value.

7. The electronic device of claim 6, wherein said first circuit comprises:
a logic unit, that receives said PWM signal and said first signal, and generates a second signal according to said PWM signal and said first signal; and
a filter, coupled to said logic unit, that converts said PWM signal into said first voltage under control of said second signal,
wherein when said first voltage is at said voltage of said battery and a duty cycle of said PWM signal is at a specified value, said first circuit is disabled under control of said first signal.

8. The electronic device of claim 6, wherein said start-up circuit comprises a comparator that generates a third signal according to a comparison of a first signal indicative of said first voltage and a second signal indicative of said voltage of said battery.

9. The electronic device of claim 8, wherein each input terminal of said comparator is coupled to a voltage divider to generate said first signal and said second signal, respectively.

10. The electronic device of claim 8, wherein said start-up circuit further comprises a flip-flop circuit coupled to said comparator and generates said first signal in response to said third signal.

11. The electronic device of claim 6, wherein said start-up circuit further comprises a logic unit that receives said PWM signal and outputs said PWM signal to start charging said battery when said first voltage is at a voltage of said battery and said duty cycle of said PWM signal is at a specified value.

12. The electronic device of claim 11, wherein said logic unit outputs an output signal in a single state when said first voltage is less than said voltage of said battery.

13. The electronic device of claim 6, wherein said duty cycle of said PWM signal is at said specified value which is proportional to said voltage of said battery

14. The electronic device of claim 6, further comprising:
a high side switch coupled to said battery; and
a low side switch, coupled to said high side switch and said battery, wherein said high said switch and said low side switch are controlled by said PWM signal to provide power to said battery when said first circuit is disabled.

15. The electronic device of claim 14, wherein said start-up circuit generates a fourth signal to disable said low side switch when said first voltage is less than said voltage of said battery.

16. A method for charging a battery by an electronic device, said method comprising:
generating a pulse width modulation (PWM) signal;
receiving said PWM signal and a first signal at a first circuit;
generating a second signal according to said first signal and said PWM signal;
converting said PWM signal into a first voltage with said first circuit under control of said second signal;
disabling said first circuit under control of said first signal; and
transferring said PWM to start providing power to said battery when said first voltage is at a voltage of said battery.

17. The method of claim 16, wherein when said first circuit is disabled, a duty cycle of said PWM signal is at a specified value which is proportional to said voltage of said battery.

18. The method of claim 16, further comprising:
comparing a first signal indicative of said first voltage with a second signal indicative of said voltage of said battery; and
generating a third signal according to a comparison of said first signal and said second signal.

19. The method of claim 18, further comprising:
generating said first signal in response to said third signal.
